(19) United States
(12) Patent Application Publication
(10) Pub. No.: US 2006/0085296 A1
(43) Pub. Date: Apr. 20, 2006

(54) Inventory modeling and management

(76) Inventor: Travis C. Strickland, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/955,375

(22) Filed: Sep. 30, 2004

(51) Int. Cl. A01K 5/02; G06F 17/50

(52) U.S. Cl. 705/28; 705/29

(57) ABSTRACT

An inventory modeling and management system and method, within an inventory distribution system having multiple fulfillment nodes and distributing an inventory of multiple stock keeping units (SKUs), comprises determining whether there are inventory excesses and shortfalls for selected SKUs at selected fulfillment nodes, and analyzing the inventory excesses and shortfalls for rebalancing opportunities and taking reserves for each selected SKU within and between the selected fulfillment nodes.

### BACKGROUND

Business entities that produce products generally have a system to distribute the products to sales outlets or customers. It is thus necessary to have an inventory management, or control, system to keep track of the products and to correlate the inventory with sales orders. The inventory management system must establish a “model” for the inventory distribution that indicates to managers, or analysts, the overall state of the inventory and the sales, i.e. the supply and demand situation. The inventory management system is very important to the business entity, because inventory in excess of demand is a financial liability.

For ease of analysis, inventory modeling and management schemes have been kept relatively simple, even as business entities have grown bigger and more complex. This practice has resulted in inventory modeling and management schemes that do not accurately describe the actual inventory situation, or the actual availability of the inventory for fulfilling sales orders. In particular, the analysis performed in inventory modeling and management schemes has merely involved a comparison of the current sales orders with the current inventory in a geographical region or at an order fulfillment “node” (i.e. a manufacturing plant, a warehouse facility, a distribution center, a sales outlet, etc.), regardless of whether the inventory can be used to fulfill those sales orders. Under this analysis technique, if there is more inventory than there are sales orders at a given fulfillment node or within a geographical region, then there is an excess which may result in a loss. On the other hand, if there are more sales orders than there is inventory, then there is a shortfall, which needs to be filled. Among other shortcomings, this analysis does not take into consideration whether any of the inventory is “non-nettable” (i.e. unusable, damaged, etc.) or is intended for order fulfillment outside of the current geographical region.

Additionally, of particular concern in inventory modeling and management schemes is a product that is nearing its end of life cycle and will soon become obsolete. In this case, the business entity does not want to be encumbered with obsolete products that customers are unwilling to buy after newer, more state-of-the-art products have come onto the market. In other words, demand may decrease to zero, so the remaining inventory may be a complete financial liability. Obsolescence modeling is, thus, an important part of inventory modeling and management. Inventory obsolescence may result in excess inventory that must be disposed of, such as by selling it at a potential loss or simply discarding it as a total loss.

Furthermore, for some products, such as various electronics, for which the prices of the components thereof may be reduced at any time, the customers will expect the price of the product to be reduced commensurate with the reduced component prices. In this case, the business entity does not want to be encumbered with a substantial amount of inventory that was built before the prices were reduced. This situation results in excess inventory that may only be sold at reduced prices that significantly erode the profit that can be made from that inventory.

To account for losses due to obsolescence or reduced pricing, business entities have generally maintained a “financial reserve” against the anticipated loss or to dispose of obsolete inventory. The amount of the reserve set aside for each product has been determined based on experience with similar types of products encountered in the past. For example, if a certain product reached the end of its life cycle with X units of obsolete inventory remaining, then it would be anticipated that the next similar product would also end its life cycle with a proportional number of units of obsolete inventory. The financial reserves for that product would thus be set in advance accordingly. Reserve planning schemes, in other words, have been “backward looking,” or “reactionary,” based on past experience. Additionally, such reserve planning schemes tended to result in having significant measurable percentage points of the business entity's budget assigned to the financial reserves, because reserve planners would over-budget for the financial reserves in order not to get caught “short” in a situation in which millions of dollars could potentially be lost.

### BRIEF DESCRIPTION OF THE DRAWINGS

FIG. 1 is a simplified map of the world showing geographical regions for an inventory modeling and management system incorporating an embodiment of the present invention.

FIG. 2 is a simplified diagram of an exemplary hierarchical structure for geographical regions for an inventory modeling and management system incorporating an embodiment of the present invention.

FIG. 3 is a simplified flow chart for a procedure to model and manage inventory according to an embodiment of the present invention.

### DETAILED DESCRIPTION

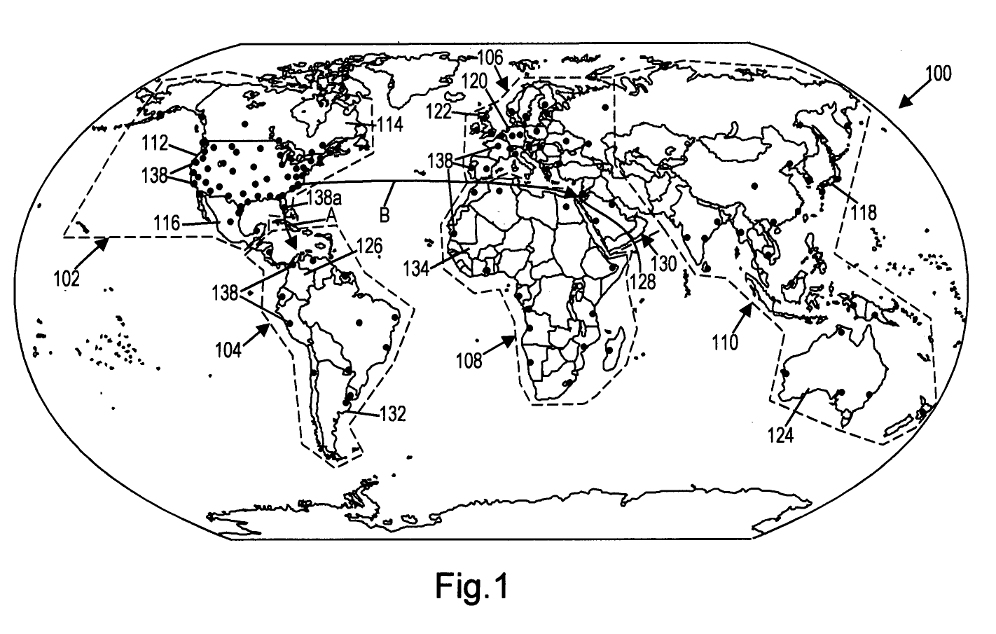

An inventory modeling and management system and process, according to embodiments of the present invention, enables a business entity to anticipate, plan for and respond to the actual inventory situation (e.g. inventory obsolescence, excesses and shortfalls) that will likely exist within a specified period of time (e.g. in the next three to six months or more) based on inventory levels, marketing forecasts, sales order demand, inventory status and routing capabilities, among other parameters as described herein. The system and process will be described with reference to a global business entity that produces and distributes products worldwide and generally divides the world 100 into several geographical regions 102-110, as shown in FIG. 1, to manage the marketing, sales, distribution and inventory of the products. The geographical regions 102-110 are a simplified example for this description. It is understood and contemplated herein, therefore, that the invention is not necessarily so limited, but may also apply to any other appropriate business entity.

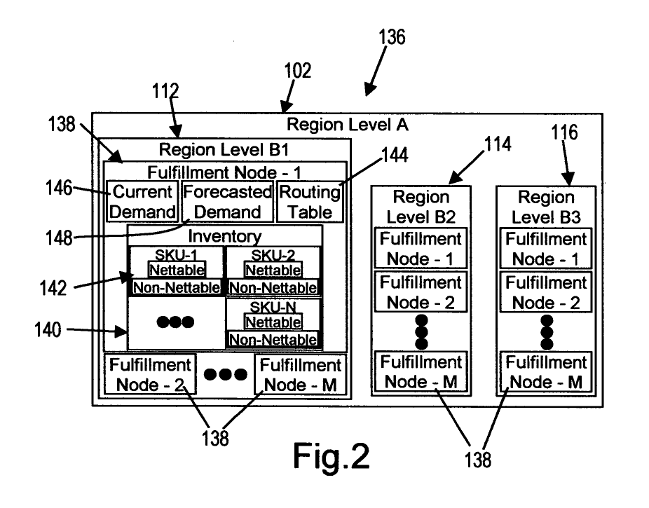

In the example shown, the geographical regions include North America 102, Latin America 104, Europe-Middle East 106, Africa 108 and Asia-Pacific 110. (Other divisions of the world 100 are also contemplated.) Each geographical region 102-110 is typically subdivided into smaller geographical regions, e.g. subregions or countries (e.g. 112-134), within which the business entity operates. The subregions or countries 112-134 may be further subdivided as needed. Such a hierarchy is illustrated by a geographical hierarchical structure 136 shown in FIG. 2, wherein geographical region level A may represent one of the geographical regions (e.g. North America 102) of the world 100, and geographical regions level B1, B2 and B3 may represent countries (e.g. United States 112, Canada 114 and Mexico 116, respectively) within the geographical region level A.

Within each of the subregions or countries 112-134 are typically one or more “order fulfillment nodes” 138 (e.g. manufacturing and/or distribution centers). The sales orders generated within the subregions or countries 112-134 are fulfilled from the order fulfillment nodes 138. For the sake of simplicity, not all subregions or countries 112-134 within which the business entity operates are shown in FIG. 1 to have an order fulfillment node 138. Additionally, due to political, economic or other reasons, the business entity may not operate in every country of the world, so there would be no order fulfillment node 138 in those countries.

Generally, sales orders that are generated in one geographical region 102-110 or subregion or country 112-134 are fulfilled from inventory at one of the order fulfillment nodes 138 within that geographical region 102-110 or subregion or country 112-134. There may be various exceptions to this general rule. For example, inventory held at a particular order fulfillment node 138 (e.g. 138a, FIG. 1) within one country (e.g. the United States 118) may be intended for use or distribution in another geographical region (e.g. Latin America 104), as indicated by arrow A. Additionally, some sales orders (e.g. government sector sales orders) generated in one subregion or country (e.g. country 128 in the Middle East 130) may be required (by contract, treaty, law, etc.) to be fulfilled from inventory located in another subregion or country (e.g. the United States 118), as indicated by arrow B, instead of from inventory located in the same geographical region (e.g. Europe-Middle East 106).

An inventory modeling and management system that considers only the physical location of the inventory and sales orders could erroneously result in an excess of inventory being declared in the United States 118 and a shortfall occurring in Latin America 104 or in country 128 in the Middle East 130 in this example. Such erroneous excess could adversely and needlessly affect the financial reserves held against the inventory in the United States 118.

According to embodiments of the present invention, on the other hand, the inventory modeling and management system described herein correlates the inventory with the routing of sales orders, thereby treating the inventory in these two examples as being available to fulfill sales orders in Latin America 104 and in country 128 in the Middle East 130, rather than in the United States 118. In this manner, the actual inventory situation is more accurately modeled, and the erroneous excesses and shortfalls are avoided.

Additionally, it may not be economically practical for inventory held in one particular country (e.g. 126) to be used to fulfill sales orders in another country (e.g. 132), even though the two countries 126 and 132 are in the same geographical region (e.g. Latin America 104). Tariffs and duties imposed by the first country 126 on finished goods leaving the country 126 can consume all of the profit that could potentially be made from the inventory if the inventory were transferred to the second country 132. According to embodiments of the present invention, the inventory modeling and management system described herein treats the inventory in this example as being available only to fulfill sales orders generated within the first country 126, since the inventory located in the first country 126 would almost never actually be used to fulfill sales orders outside of that country 126. In this manner, the actual inventory situation is more accurately modeled.

For each fulfillment node 138, the inventory 140 (FIG. 2) located therein is divided into different SKUs 142 (stock keeping units) or product or part numbers. Each item of each SKU 142 is further identified by its “nettable” (i.e. usable, sellable, etc.) or “non-nettable” (i.e. not usable, not sellable, damaged, etc.) status. Additionally, information is maintained for the inventory 140 for each fulfillment node 138 by which sales orders are associated with the inventory 140 to fulfill the sales orders, including as in the above examples. This information is referred to as a “routing table” 144, or a portion thereof. Furthermore, the existing sales orders (current demand 146) and the marketing forecast (forecasted demand 148) for each fulfillment node 138 are maintained. According to embodiments of the present invention, correlation of this information (the inventory 140, the routing table 144, the current demand 146 and the forecasted demand 148) enables the availability, status and/or destination of each item of each SKU 142 of the inventory 140 for each fulfillment node 138 to be accounted for over a period of time (e.g. the next three to six months or more). Additionally, it is contemplated that various embodiments of the present invention may select all or only a portion of the SKUs 142 and fulfillment nodes 138 for use with the present invention.

The routing table 144 is generally used to determine the source (e.g. an inventory warehouse/distribution center or an inventory build/manufacturing plant) of the required inventory unit to fulfill a given sales order depending on the location where the sales order was placed. The routing table 144, according to some embodiments, thus contains information regarding the sales entity that received the sales order, the SKU 142 that is the subject of the sales order, the manufacturing fulfillment node 138 at which the unit of the SKU 142 may be built, the warehouse fulfillment node 138 at which the unit of the SKU 142 may be held in inventory and the priority by which the sales order is fulfilled. With the routing table 144, thus, it is possible to determine the order and preferences for the fulfillment nodes 138 that can fulfill a given sales order generated in a given region. In other words, the routing table 144 is used to determine to where the current sales orders and the forecasted demand will be routed to be fulfilled. For example, if a sales order is placed in country 120 for a particular product, then the routing table 144 is used to determine whether the nearest fulfillment node 138 in the same country 120 can fulfill the sales order, assuming that the cost and time for shipping the unit will usually be most economical from the nearest fulfillment node 138. If so, then the sales order is fulfilled at that fulfillment node 138. If not, however, then the routing table 144 is used to determine whether the sales order can be fulfilled at another fulfillment node 138 (e.g. an outbound warehouse in country 122). If there is no available unit at that fulfillment node 138 in the country 122, as in this example, then the routing table 144 is used to place the sales order demand on yet another fulfillment node 138 (e.g. a manufacturing plant in country 122) to build the unit. As another example, if a fulfillment node 138 in a particular country (e.g. 126) cannot economically fulfill a sales order generated in another country or region (e.g. 132), e.g. due to duties, tariffs and/or taxes imposed by the first country 126, then the routing table 144 takes this situation into account by excluding the first country 126 from the potential routing sites for the sales orders generated in the second country 132. Furthermore, other relevant information is included in the routing table 144, such as the price of the unit, the lead times associated with transferring the unit or its components, etc.

The current demand 146 generally includes the sales orders that are currently booked with the business entity at the time that the current demand 146 information is assembled for each fulfillment node 138. According to various embodiments, the current demand 146, thus, lists the products on order, the regions where the sales orders originated, the entities that placed the sales orders, the amount of the sales orders, etc.

The forecasted demand 148 generally includes marketing demand forecasts for each fulfillment node 138, each sales organization and/or each subregion or country 112-134 for a given period of time (e.g. a few weeks and/or months). The individual marketing demand forecasts for each part or segment of the business entity are combined to form a forecasted demand for each geographical region 102-110 and the overall business entity. Sales organizations are treated like, or correlated with, forecasting organizations in order to accurately and properly reflect the correct geographical regions 102-110 or subregion or country 112-134 for the marketing demand forecasts for each fulfillment node 138. According to various embodiments of the present invention, the marketing demand forecasts are used along with current demand 146, the routing table 144 and the inventory 140 to anticipate the inventory excesses as described herein, so that appropriate proactive measures may be taken to lessen financial losses.

The inventory modeling and management system enables a forward-looking, proactive, extrapolated indication of excess inventory and the potential financial exposure to excess or obsolete inventory based on a combination of current and forecasted market conditions. Additionally, the inventory modeling and management system accounts for demand that is not specific to one geographical region 102-110 or subregion or country 112-134, but which can be fulfilled from multiple locations across the world 100. Furthermore, the inventory 140 at one fulfillment node 138 may be used at another fulfillment node 138 to fulfill sales orders. With this capability, the inventory modeling and management system enables identification of opportunities to “rebalance” inventory between fulfillment nodes 138, subregion or country 112-134 and/or geographical region 102-110. Also, the inventory modeling and management system enables a much more realistic method of determining the financial reserves that may have to be held back to account for inventory excesses. Thus, the inventory modeling and management system saves money over the prior art.

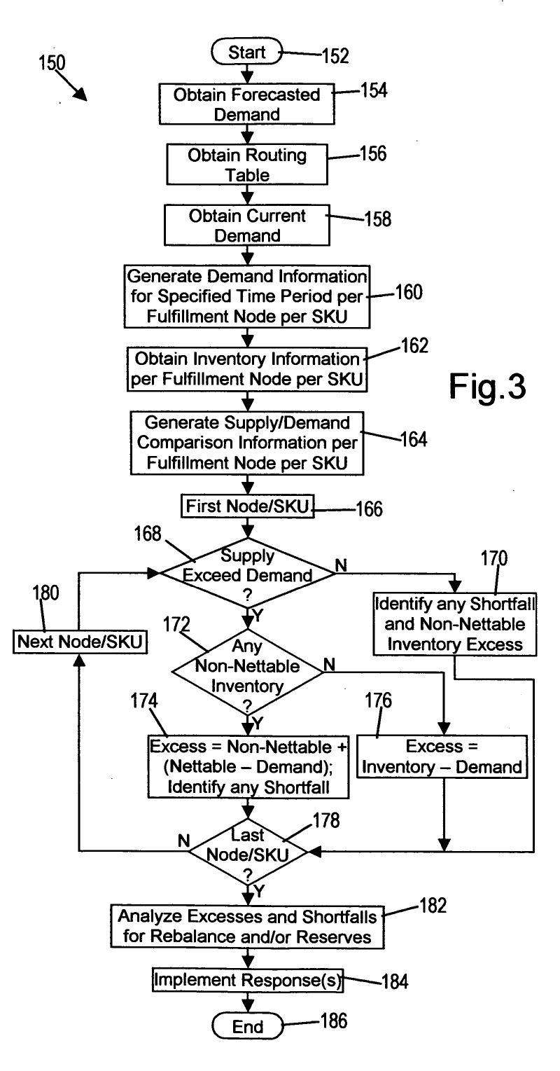

A exemplary procedure 150 for modeling and managing inventory according to an embodiment of the present invention is shown in FIG. 3. Upon starting (at 152), the forecasted demand 148, the routing table 144 and the current demand 146 are obtained (at 154, 156 and 158). With such information thus obtained, the overall actual and anticipated “demand information” (or demand “image,” “situation” or “horizon”) is generated (at 160) for a specified time period per fulfillment node 138 per SKU 142 for the business entity. In other words, it is thus determined what the market conditions indicate the business entity should be able to fulfill in the near to mid term future (i.e. the specified time period) at each fulfillment node 138 for each product in every region. The demand information for the specified time period may be divided into smaller time periods (e.g. weeks, months, both, etc.) for a finer presentation of the demand information. Inventory analysts for each region or the overall business entity may view the demand information (e.g. as a table) to analyze the demand situation at any or all of the fulfillment nodes 138.

At 162, the inventory information is obtained per fulfillment node 138 per SKU 142 for the business entity. The inventory information describes the inventory 140 at each of the fulfillment nodes 138. Thus, the inventory information includes not only the quantity of each SKU 142 at each fulfillment node 138, but also the status of each unit of the inventory 140, such as whether each unit is nettable or non-nettable.

From the inventory information obtained at 162 and the demand information generated at 160, supply-and-demand side-by-side comparison information is generated (at 164) per fulfillment node 138 per SKU 142 for the business entity. In this manner, the inventory (supply) and the actual and anticipated sales orders (demand) are matched together, quantity-to-quantity, at the SKU and fulfillment node level. The supply-and-demand comparison information, thus, provides an inventory value and a demand value (at a particular fulfillment node 138 for a particular SKU 142) that can be viewed to determine an inventory excess or shortfall at the particular fulfillment node 138 for the particular SKU 142.

The inventory excess/shortfall determination (and appropriate response, if any) proceeds at 166 with selection of the first fulfillment node 138 and SKU 142 to be analyzed. For this SKU 142 at this fulfillment node 138, it is determined (at 168) from the supply-and-demand comparison information whether the supply exceeds the demand. This determination may involve current inventory on hand plus inventory that is due to be shipped and received at the fulfillment node 138 within the specified time period. Likewise, this determination may also involve current sales orders plus anticipated sales orders according to the forecasted demand. In this manner, the inventory excess/shortfall determination may anticipate excesses and/or shortfalls before they occur within the specified time period. If the actual and anticipated supply does not exceed the actual and anticipated demand, as determined at 168, then any shortfall and non-nettable inventory are identified (at 170) for the current SKU 142 at the current fulfillment node 138. Any non-nettable inventory is always considered excess and is taken into account in identifying any shortfall. On the other hand, if the actual and anticipated supply exceeds the actual and anticipated demand for the current SKU 142 at the current fulfillment node 138, as determined at 168, then it is further determined (at 172) whether any of the inventory is non-nettable. If so, then the exposure to inventory excess (determined at 174) is the non-nettable inventory plus the nettable inventory minus the demand value, assuming the nettable inventory is greater than the demand value. If the nettable inventory is not greater than the demand value, then an inventory shortfall may be identified in addition to the excess at 174. If none of the inventory is non-nettable, as determined at 172, then the exposure to inventory excess (determined at 176) is the inventory value minus the demand value, and there is no shortfall. At this point, any inventory excess and/or shortfall for the current SKU 142 at the current fulfillment node 138 have been identified, whether at 170, 174 or 176.

It is determined at 178, whether the current SKU 142 and fulfillment node 138 are the last to be analyzed. If not, then the next SKU 142 and fulfillment node 138 are selected at 180, and the identification of any inventory excess and/or shortfall for this SKU 142 at this fulfillment node 138 is repeated (at 168-176).

Once all of the SKUs 142 at all of the fulfillment nodes 138 have been analyzed for inventory excesses and/or shortfalls, as indicated at 178, then the inventory excesses and shortfalls are analyzed (at 182) for any inventory rebalancing opportunities and/or the need to take financial reserves against any losses. In other words, inventory analysts review the inventory excesses and shortfalls (either manually or automatically by computer-assisted means) in order to select appropriate responses to the overall inventory situation. In manual review of the inventory excesses and shortfalls, the information may be presented first by SKU 142 and then by fulfillment node 138. In this manner, all of the shortfalls and excesses worldwide for a particular SKU 142 are shown side-by-side, so the analysts can quickly see any rebalancing opportunities between the fulfillment nodes 138 that have excesses and those that have shortfalls of that SKU 142 anywhere in the world. The selected responses are then implemented at 184, and the procedure 150 ends at 186.

The responses selected at 182 may depend on the various situations that may be encountered. The responses generally involve either anticipating the excess and responding proactively to avoid the excess in the first place, reusing the inventory in some appropriate manner, taking the excess inventory units apart and reusing the components thereof or scrapping the excess inventory. Consideration of each potential response in any situation may indicate the most cost-effective approach to take.

For instance, an inventory excess that is anticipated, rather than actual, at a given distribution center fulfillment node 138 may be the result of having ordered too many units of the affected SKU 142 to be built and shipped by a manufacturing plant fulfillment node 138. Therefore, this situation may possibly be handled by reducing the order, so the anticipated excess doesn't actually occur.

On the other hand, an actual inventory excess of a particular SKU 142 at a given fulfillment node 138 may be handled by an inventory rebalancing. In this case, units of the affected SKU 142 are transferred from the given fulfillment node 138 to a fulfillment node 138 where there is a shortfall of the same SKU 142. In other words, the excess inventory is reused by re-allocating it to a different fulfillment node 138 anywhere in the world where it is economically feasible to ship the inventory. For excess inventory located in a country that has relatively high duties or tariffs on goods leaving the country, reallocation of the excess inventory to another country may be cost-prohibitive. On the other hand, excess inventory allocated to one country, but held in a second country, may be easily re-allocated to another organization within the second country.

Additionally, rebalancing opportunities for excess inventory of an SKU 142 may be compared with any rebalancing opportunities for separate components, or raw materials, of the units of the SKU 142. In this case, the components may be more valuable than the whole unit, so it may be preferable to reuse the components, instead of the units, e.g. by selling the components as spare parts for other units, returning the components to a manufacturing plant fulfillment node 138 to build a new unit, etc. Reuse of the components, in fact, may provide more flexibility for rebalancing opportunities, since the components may be usable in units of other SKUs 142. Reuse of the components may also be the only way to handle non-nettable inventory, other than throwing it away. For an SKU 142 at the end of its life cycle, however, the components may also be at the end of their life cycle, so throwing it away may be the only option.

In the event of an actual inventory excess for which there are no rebalancing opportunities, the financial reserves may have to be taken. In this case, the inventory may be thrown away and the financial reserves taken against the total value of the inventory. Alternatively, the inventory may be sold for scrap or below cost or on the “gray” market and the financial reserves taken against the overall actual loss, instead of against the total value of the inventory.

Additionally, the excess/shortfall analysis described herein enables a more accurate prediction of the risk of exposure to obsolete inventory as the end-of-life cycle of an SKU 142 comes within the specified time period of the analysis, as determined by appropriate life-cycle management data. Therefore, for an unavoidable inventory excess that will be greater than (or less than) that which may have been originally predicted for the end-of-life cycle of the SKU 142, the financial reserves originally set aside for any eventual excess may be increased (or decreased) ahead of time. Moreover, as the end-of-life cycle of an SKU 142 comes within the specified time period of the excess/shortfall analysis, it becomes possible to more accurately determine how to “ramp down” the production and marketing of the SKU 142, so that obsolete inventory excesses can be minimized.

We claim:

1. A method for modeling and managing inventory within an inventory distribution system having multiple fulfillment nodes and distributing an inventory of multiple stock keeping units (SKUs), comprising:
selecting at least one SKU and at least one fulfillment node;
determining whether there are inventory excesses and shortfalls for each selected SKU at each selected fulfillment node; and
analyzing the inventory excesses and shortfalls for rebalancing opportunities and taking reserves for each selected SKU within and between the selected fulfillment nodes.

2. A method as defined in claim 1 further comprising:
determining whether the inventory excesses and shortfalls may occur for each selected SKU at each selected fulfillment node over a period of time.

3. A method as defined in claim 2 wherein:
the period of time includes a current month and a next two months.

4. A method as defined in claim 1 wherein:
the analyzing takes into account a cost of transferring the excess inventory between the selected fulfillment nodes.

5. A method as defined in claim 1 wherein:
the determining and the analyzing include actual and anticipated inventory excesses and shortfalls.

6. A method as defined in claim 5 wherein:
the determining and the analyzing include the actual and anticipated inventory excesses and shortfalls over a period of time.

7. A method as defined in claim 1 wherein:
the determining and the analyzing take into account a nettable and non-nettable status of the inventory.

8. A method as defined in claim 1 further comprising:
generating supply/demand comparison information for each selected SKU at each selected fulfillment node; and
determining whether there are the inventory excesses and shortfalls for each selected SKU at each selected fulfillment node from the supply/demand comparison information.

9. A method as defined in claim 8 further comprising:
generating demand information for each selected SKU at each selected fulfillment node;
obtaining inventory supply information for each selected SKU at each selected fulfillment node; and
generating the supply/demand comparison information for each selected SKU at each selected fulfillment node from the inventory supply information and the demand information.

10. A method as defined in claim 9 further comprising:
obtaining marketing forecast information, plant routing information and current demand information for each selected SKU at each selected fulfillment node; and
generating the demand information for each selected SKU at each selected fulfillment node from the marketing forecast information, the plant routing information and the current demand information.

11. A method as defined in claim 1, wherein selected sales orders are received for the SKUs, further comprising:
obtaining plant routing information for each selected SKU at each selected fulfillment node;
using the plant routing information to determine the selected fulfillment nodes at which the selected sales orders will be fulfilled; and
determining whether there are the inventory excesses and shortfalls for each selected SKU at each selected fulfillment node based at least partly on the determination of the selected fulfillment nodes at which the selected sales orders will be fulfilled.

12. A method for modeling and managing inventory within an inventory distribution system having multiple fulfillment nodes and distributing an inventory of multiple stock keeping units (SKUs), comprising:
selecting at least one SKU and at least one fulfillment node;
determining a nettable and non-nettable status of the inventory for the selected SKUs and fulfillment nodes;
for each selected SKU and fulfillment node, determining whether there are inventory excesses and shortfalls taking into account the nettable and non-nettable status of the inventory; and
analyzing the inventory excesses and shortfalls for rebalancing opportunities and taking reserves.

13. A method as defined in claim 12 further comprising:
for each selected SKU and fulfillment node, if there is non-nettable inventory, determining the inventory excess for the SKU at the fulfillment node to include at least the non-nettable inventory of the SKU.

14. A method as defined in claim 13 further comprising:
for each selected SKU and fulfillment node, if there is nettable inventory and the nettable inventory exceeds a demand for the SKU at the fulfillment node, determining the inventory excess for the SKU at the fulfillment node to include at least the nettable inventory minus the demand of the SKU.

15. A method as defined in claim 14 wherein:
the demand for each selected SKU at each selected fulfillment node includes an actual demand and an anticipated demand.

16. A method as defined in claim 13 further comprising:
for each selected SKU and fulfillment node, if there is nettable inventory and a demand exceeds the nettable inventory for the SKU at the fulfillment node, determining the inventory shortfall for the SKU at the fulfillment node to include the demand minus the nettable inventory of the SKU.

17. A method as defined in claim 16 wherein:
the demand for each selected SKU at each selected fulfillment node includes an actual demand and an anticipated demand.

18. A method as defined in claim 12 further comprising:
for at least one selected SKU and fulfillment node, if there is excess inventory, determining the nettable and non-nettable status of components of the excess inventory; and
analyzing the excess inventory for rebalancing opportunities for any components having the nettable status.

19. A method as defined in claim 12 further comprising:
obtaining marketing forecast information, plant routing information and current demand information for each selected SKU and fulfillment node;
generating demand information for each selected SKU and fulfillment node from the marketing forecast information, the plant routing information and the current demand information;
obtaining inventory supply information for each selected SKU and fulfillment node;
generating supply/demand comparison information for each selected SKU and fulfillment node from the inventory supply information and the demand information; and
determining whether there are the inventory excesses and shortfalls for each selected SKU and fulfillment node also from the supply/demand comparison information.

20. A method for modeling and managing inventory within an inventory distribution system having multiple fulfillment nodes and distributing an inventory of multiple stock keeping units (SKUs), comprising:
selecting at least one SKU and at least one fulfillment node;
obtaining marketing forecast information, plant routing information and current demand information for each selected SKU at each selected fulfillment node;
generating demand information for each selected SKU at each selected fulfillment node from the marketing forecast information, the plant routing information and the current demand information;
obtaining inventory supply information for each selected SKU at each selected fulfillment node;
generating supply/demand comparison information for each selected SKU at each selected fulfillment node from the inventory supply information and the demand information;
for each selected SKU and fulfillment node, determining whether there are inventory excesses and shortfalls from the supply/demand comparison information; and
analyzing the inventory excesses and shortfalls for rebalancing opportunities and taking reserves for each selected SKU.

21. A method as defined in claim 20 further comprising:
determining whether there are the inventory excesses and shortfalls as may occur over a period of time.

22. A method as defined in claim 20 wherein:
the analyzing takes into account a cost of transferring the excess inventory between the selected fulfillment nodes.

23. A inventory modeling and managing system for use within an inventory distribution system having multiple fulfillment nodes and distributing an inventory of multiple stock keeping units (SKUs), comprising:
a means for generating demand information for selected SKUs at selected fulfillment nodes from marketing forecast information, plant routing information and current demand information;
a means for generating supply/demand comparison information for each selected SKU at each selected fulfillment node from inventory supply information and the demand information;
a means for determining whether there are inventory excesses and shortfalls for each selected SKU at each selected fulfillment node from the supply/demand comparison information and taking into account a nettable and non-nettable status of the inventory; and
a means for analyzing the inventory excesses and shortfalls for rebalancing opportunities and taking reserves for each selected SKU within and between the selected fulfillment nodes.
